(19) United States
(12) Patent Application Publication
(10) Pub. No.: US 2026/0044586 A1
(43) Pub. Date: Feb. 12, 2026

(54) IMAGE DISPLAY DEVICE

(71) Applicant: LG ELECTRONICS INC., Seoul (KR)

(72) Inventors: Junghoon PARK, Seoul (KR); Jaeung HAN, Seoul (KR); Dongcheon PARK, Seoul (KR); Beomsuk KOH, Seoul (KR); Junwoo HA, Seoul (KR)

(73) Assignee: LG ELECTRONICS INC., Seoul (KR)

(21) Appl. No.: 18/998,922

(22) PCT Filed: Jul. 26, 2022
(86) PCT No.: PCT/KR2022/010933

§ 371 Date: Jan. 27, 2025

(51) Int. Cl. G06F 21/32; G06F 21/81; G06F 21/88

(52) U.S. Cl. CPC G06F 21/32; G06F 21/81; G06F 21/88

(57) ABSTRACT

An image display apparatus is disclosed. An image display apparatus according to one embodiment of the present disclosure comprises a camera, a display, a memory configured to store facial images of a registered user, and a signal processing device configured to enter a monitoring mode in response to changes in images captured by the camera exceeding a predetermined value during operation, wherein, in response to a facial image within images captured through the camera does not matching a facial image stored in the memory during the monitoring mode operation, the signal processing device is configured to determine a theft situation and output an alarm or transmit the images captured through the camera to the outside. Accordingly, a theft situation can be accurately detected in real-time.

### BACKGROUND

### 1. Field of the Cisclosure

The present disclosure relates to an image display apparatus, and more particularly, to an image display apparatus capable of accurately detecting a theft situation in real-time.

### 2. Description of the Related Art

An image display apparatus is an apparatus equipped with a function for providing videos that a user may watch. The user may watch various video contents through the image display apparatus.

For example, if the image display apparatus is a portable image display apparatus, the user may use the image display apparatus in public places. In such a case, the image display apparatus becomes vulnerable to theft if the user leaves the image display apparatus unattended temporarily.

The Korean Patent Publication No. 10-2017-0054028 (in what follows, referred to as “prior art literature”), related to an operation method for an image display apparatus, particularly a laptop computer, discloses an image display apparatus that enters a theft monitoring mode to detect and respond to a theft situation.

However, according to the prior art literature, since theft detection relies on keyboard and mouse inputs, the laptop computer may cause a problem of potentially misidentifying a theft situation when the registered user operates the laptop computer without using the keyboard or mouse.

### SUMMARY

An object of the present disclosure is to provide an image display apparatus capable of accurately detecting a theft situation in real-time.

Another object of the present disclosure is to provide an image display apparatus capable of improving the likelihood of recovery in theft situations.

Yet another object of the present disclosure is to provide an image display apparatus capable of minimizing personal information exposure in theft situations.

To achieve the objectives above, an image display apparatus according to one embodiment of the present disclosure comprises a camera, a display, a memory configured to store facial images of a registered user, and a signal processing device configured to enter a monitoring mode in response to changes in images captured by the camera exceeding a predetermined value during operation, wherein, in response to a facial image within images captured through the camera does not matching a facial image stored in the memory during the monitoring mode operation, the signal processing device is configured to determine a theft situation and output an alarm or transmit the images captured through the camera to the outside.

Meanwhile, the signal processing device may be configured to operate in a normal mode in response to the facial image captured by the camera matching the facial image stored in the memory during operation; in response to the facial image captured by the camera does not matching the facial image stored in the memory for a predetermined period, the signal processing device may be configured to enter the monitoring mode.

Meanwhile, the image display apparatus according to one embodiment of the present disclosure may further comprise an input device including a power key and a character key, wherein the signal processing device may be configured to determine a theft situation and output an alarm or transmit the image captured through the camera to the outside in response to the facial image within the image captured through the camera not matching the facial image stored in the memory and no input being detected from the power key or the character key for a predetermined period during operation in the monitoring mode.

Meanwhile, in response to determining the theft situation, the signal processing device may be configured to lock the screen of the display and prevent the power mode from entering an off mode or a power saving mode.

Meanwhile, in response to determining the theft situation, the signal processing device may be configured to not to turn off power when a power-off input is applied via a power key or reboot after power-off.

Meanwhile, in response to determining the theft situation, the signal processing device may be configured to lock BIOS data or personal information data stored in the memory.

Meanwhile, the image display apparatus according to one embodiment of the present disclosure may further comprise a network interface configured to perform wireless communication with an adjacent access point device, wherein the signal processing device may be configured to connect wirelessly to the access point device in response to determining the theft situation and transmit the image captured through the camera to a registered mobile terminal or a server.

Meanwhile, the signal processing device may be configured to activate only a portion of internal devices during a power saving mode operation and perform monitoring based on the activated portion of the internal devices and, in response to the monitoring result indicating a theft situation, further wake up other internal devices and output the alarm or transmit images captured through the camera to the outside.

Meanwhile, the image display apparatus according to one embodiment of the present disclosure may further comprise a network interface configured to perform wireless communication with an adjacent access point device and an audio output device configured to output sound, wherein the signal processing device may be configured to activate the camera during the power saving mode operation, determine the theft situation in response to the facial image captured by the camera does not matching the facial image stored in the memory, activate the network interface and the audio output device, and output an alarm through the audio output device or transmit images captured through the camera to the outside through the network interface.

Meanwhile, in response to a forced shutdown input being detected during the monitoring mode operation, the signal processing device may be configured to output an alarm and store an alarm mode flag in the memory.

Meanwhile, the image display apparatus according to one embodiment of the present disclosure may further comprise a power supply configured to output DC power, an input device configured to output a power-on signal or a power-off signal based on the operation of a power key, and a controller configured to enter a power saving mode or a standby mode and controlling a DC/DC converter within the power supply to turn off in response to the power-off signal being received or a power saving or standby mode signal being input, and turn on the DC/DC converter within the power supply in response to the power-on signal being received.

Meanwhile, the controller may be configured to turn off the power supply in response to the power-off signal being received or the power saving or standby mode signal being input and turn on the power supply in response to the power-on signal being received, wherein the power supply may be configured to perform DC power conversion based on the power-on signal and supply the converted DC power to each device within the image display apparatus.

Meanwhile, the power supply may include a battery configured to store DC power input from an external source, the DC/DC converter configured to convert the DC power input from the external source or DC power stored in the battery and output the converted DC power, and a second DC/DC converter configured to adjust the level of the DC power converted from the DC/DC converter and output the adjusted DC power.

Meanwhile, the image display apparatus according to one embodiment of the present disclosure may further include a power management controller configured to receive a power-on signal from the signal processing device, wherein the power management controller may be configured to output a control signal to the second DC/DC converter within the power supply in response to receiving of the power-on signal.

An image display apparatus according to another embodiment of the present disclosure comprises a camera, a display, and a memory configured to store facial images of a registered user, and a signal processing device configured to activate only a portion of internal devices during a power saving mode operation and perform monitoring based on the portion of the internal devices, wherein, in response to the monitoring result indicating a theft situation, the signal processing device is configured to further wake up other internal devices among the internal devices and output an alarm or transmit images captured through the camera to the outside.

Meanwhile, an image display apparatus according to another embodiment of the present disclosure may further comprise a network interface configured to perform wireless communication with an adjacent access point device and an audio output device configured to output sound, wherein the signal processing device may be configured to activate the camera during the power saving mode operation, determine the theft situation in response to the facial image captured by the camera does not matching the facial image stored in the memory, activate the network interface and the audio output device, and output an alarm through the audio output device or transmit images captured through the camera to the outside through the network interface.

Meanwhile, in response to a forced shutdown input being detected during the monitoring mode operation, the signal processing device may be configured to output an alarm and store an alarm mode flag in the memory.

### EFFECTS OF THE DISCLOSURE

An image display apparatus according to one embodiment of the present disclosure comprises a camera, a display, a memory configured to store facial images of a registered user, and a signal processing device configured to enter a monitoring mode in response to changes in images captured by the camera exceeding a predetermined value during operation, wherein, in response to a facial image within images captured through the camera does not matching a facial image stored in the memory during the monitoring mode operation, the signal processing device is configured to determine a theft situation and output an alarm or transmit the images captured through the camera to the outside. Accordingly, a theft situation can be accurately detected in real-time. Also, the likelihood of recovery in theft situations can be improved.

Meanwhile, the signal processing device may be configured to operate in a normal mode in response to the facial image captured by the camera matching the facial image stored in the memory during operation; in response to the facial image captured by the camera does not matching the facial image stored in the memory for a predetermined period, the signal processing device may be configured to enter the monitoring mode. Accordingly, a theft situation can be accurately detected in real-time.

Meanwhile, the image display apparatus according to one embodiment of the present disclosure may further comprise an input device including a power key and a character key, wherein the signal processing device may be configured to determine a theft situation and output an alarm or transmit the image captured through the camera to the outside in response to the facial image within the image captured through the camera not matching the facial image stored in the memory and no input being detected from the power key or the character key for a predetermined period during operation in the monitoring mode. Accordingly, a theft situation can be accurately detected in real-time. Also, the likelihood of recovery in theft situations can be improved.

Meanwhile, in response to determining the theft situation, the signal processing device may be configured to lock the screen of the display and prevent the power mode from entering an off mode or a power saving mode. Accordingly, personal information exposure may be minimized in theft situations.

Meanwhile, in response to determining the theft situation, the signal processing device may be configured to not to turn off power when a power-off input is applied via a power key or reboot after power-off.

Meanwhile, in response to determining the theft situation, the signal processing device may be configured to lock BIOS data or personal information data stored in the memory. Accordingly, personal information exposure may be minimized in theft situations.

Meanwhile, the image display apparatus according to one embodiment of the present disclosure may further comprise a network interface configured to perform wireless communication with an adjacent access point device, wherein the signal processing device may be configured to connect wirelessly to the access point device in response to determining the theft situation and transmit the image captured through the camera to a registered mobile terminal or a server. Accordingly, the likelihood of recovery in theft situations can be improved.

Meanwhile, the signal processing device may be configured to activate only a portion of internal devices during a power saving mode operation and perform monitoring based on the activated portion of the internal devices and, in response to the monitoring result indicating a theft situation, further wake up other internal devices and output the alarm or transmit images captured through the camera to the outside. Accordingly, a theft situation can be accurately detected in real-time. Also, the likelihood of recovery in theft situations can be improved.

Meanwhile, the image display apparatus according to one embodiment of the present disclosure may further comprise a network interface configured to perform wireless communication with an adjacent access point device and an audio output device configured to output sound, wherein the signal processing device may be configured to activate the camera during the power saving mode operation, determine the theft situation in response to the facial image captured by the camera does not matching the facial image stored in the memory, activate the network interface and the audio output device, and output an alarm through the audio output device or transmit images captured through the camera to the outside through the network interface. Accordingly, a theft situation can be accurately detected in real-time. Also, the likelihood of recovery in theft situations can be improved.

Meanwhile, in response to a forced shutdown input being detected during the monitoring mode operation, the signal processing device may be configured to output an alarm and store an alarm mode flag in the memory. Accordingly, the likelihood of recovery in theft situations can be improved.

Meanwhile, the image display apparatus according to one embodiment of the present disclosure may further comprise a power supply configured to output DC power, an input device configured to output a power-on signal or a power-off signal based on the operation of a power key, and a controller configured to enter a power saving mode or a standby mode and controlling a DC/DC converter within the power supply to turn off in response to the power-off signal being received or a power saving or standby mode signal being input, and turn on the DC/DC converter within the power supply in response to the power-on signal being received. Accordingly, power consumption may be reduced in the standby mode.

Meanwhile, the controller may be configured to turn off the power supply in response to the power-off signal being received or the power saving or standby mode signal being input and turn on the power supply in response to the power-on signal being received, wherein the power supply may be configured to perform DC power conversion based on the power-on signal and supply the converted DC power to each device within the image display apparatus. Accordingly, power consumption may be reduced in the standby mode.

Meanwhile, the power supply may include a battery configured to store DC power input from an external source, the DC/DC converter configured to convert the DC power input from the external source or DC power stored in the battery and output the converted DC power, and a second DC/DC converter configured to adjust the level of the DC power converted from the DC/DC converter and output the adjusted DC power. Accordingly, power consumption may be reduced in the standby mode.

Meanwhile, the image display apparatus according to one embodiment of the present disclosure may further include a power management controller configured to receive a power-on signal from the signal processing device, wherein the power management controller may be configured to output a control signal to the second DC/DC converter within the power supply in response to receiving of the power-on signal. Accordingly, power consumption may be reduced in the standby mode.

An image display apparatus according to another embodiment of the present disclosure comprises a camera, a display, and a memory configured to store facial images of a registered user, and a signal processing device configured to activate only a portion of internal devices during a power saving mode operation and perform monitoring based on the portion of the internal devices, wherein, in response to the monitoring result indicating a theft situation, the signal processing device is configured to further wake up other internal devices among the internal devices and output an alarm or transmit images captured through the camera to the outside. Accordingly, a theft situation can be accurately detected in real-time. Also, the likelihood of recovery in theft situations can be improved.

Meanwhile, an image display apparatus according to another embodiment of the present disclosure may further comprise a network interface configured to perform wireless communication with an adjacent access point device and an audio output device configured to output sound, wherein the signal processing device may be configured to activate the camera during the power saving mode operation, determine the theft situation in response to the facial image captured by the camera does not matching the facial image stored in the memory, activate the network interface and the audio output device, and output an alarm through the audio output device or transmit images captured through the camera to the outside through the network interface. Accordingly, a theft situation can be accurately detected in real-time. Also, the likelihood of recovery in theft situations can be improved.

Meanwhile, in response to a forced shutdown input being detected during the monitoring mode operation, the signal processing device may be configured to output an alarm and store an alarm mode flag in the memory. Accordingly, a theft situation can be accurately detected in real-time. Also, the likelihood of recovery in theft situations can be improved.

### BRIEF DESCRIPTION OF THE DRAWINGS

FIG. 1 is an example of an image display apparatus according to an embodiment of the present disclosure.

FIG. 2 is an example of an internal block diagram of the image display apparatus of FIG. 1.

FIG. 3 is an example of an internal block diagram of a signal processing device of FIG. 2.

FIG. 4 is a diagram referenced to describe an example of operation of the control and the power supply of FIG. 2.

FIG. 5 is a flow diagram illustrating an example of an operation method of an image display apparatus according to an embodiment of the present disclosure.

FIGS. 6a to 6d are drawings referenced to describe the operation method of FIG. 5.

FIG. 7 is a flow diagram illustrating another example of an operation method of an image display apparatus according to an embodiment of the present disclosure.

FIGS. 8a to 8d are drawings referenced to describe the operation method of FIG. 7.

FIG. 9 is a flow diagram illustrating another example of an operation method of an image display apparatus according to an embodiment of the present disclosure.

FIGS. 10a to 10c are drawings referenced to describe the operation method of FIG. 9.

FIG. 11 is a flow diagram illustrating yet another example of an operation method of an image display apparatus according to an embodiment of the present disclosure.

### DETAILED DESCRIPTION OF THE PREFERRED EMBODIMENTS

Hereinafter, the present disclosure will be described in detail with reference to the accompanying drawings.

With respect to constituent elements used in the following description, suffixes “module” and “unit” are given only in consideration of ease in preparation of the specification, and do not have or serve different meanings. Accordingly, the suffixes “module” and “unit” may be used interchangeably.

An image display apparatus according to an embodiment of the present disclosure may refer to the concept that includes laptop computers, desktop computers, TVs, and vehicle displays. Furthermore, the image display apparatus according to an embodiment of the present disclosure may refer to the concept that includes mobile devices such as mobile phones, tablets, smartwatches, and smart glasses.

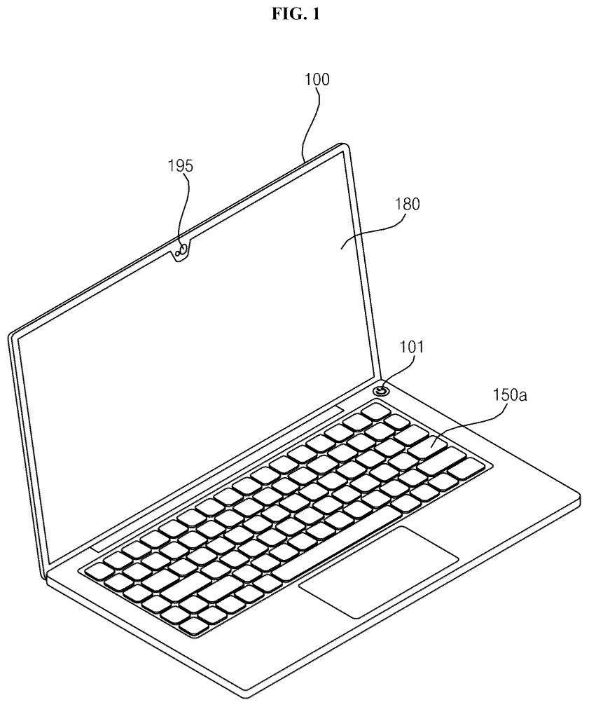

FIG. 1 is an example of an image display apparatus according to an embodiment of the present disclosure.

Referring to the figure, the image display apparatus 100 according to an embodiment of the present disclosure may be a laptop computer.

The laptop computer may be equipped with a display 180, character keys 150a, and a power key 101.

The character key 150a and the power key 101 are examples of input devices, which may be part of the input device 120 to be described later.

The laptop computer 100, as a portable image display apparatus, may be used in public places and is vulnerable to theft when the user temporarily leaves their seat.

The present disclosure proposes a method for accurately detect a theft situation in real-time and improving the likelihood of recovery in theft situations.

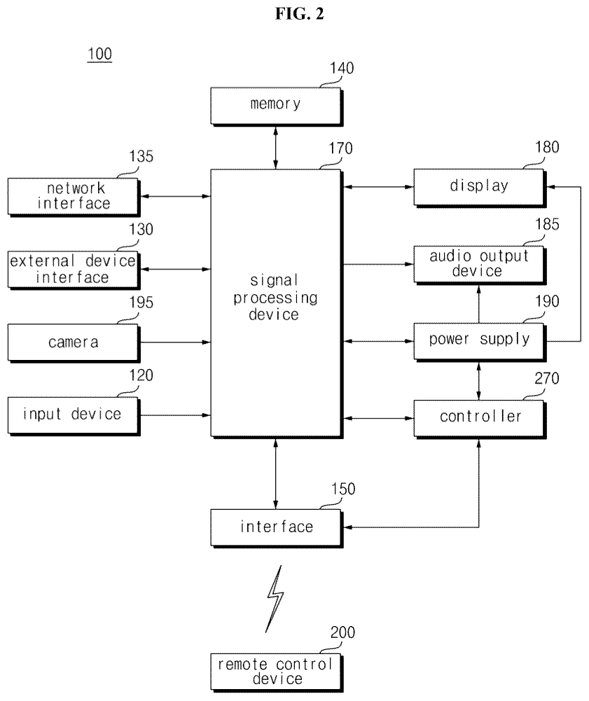

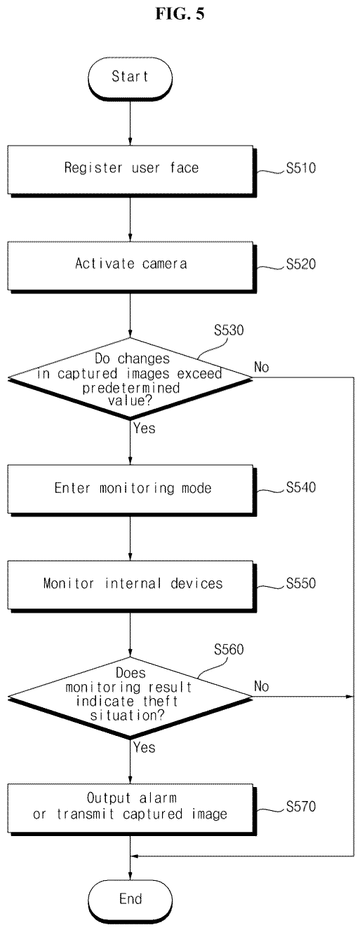

To this end, an image display apparatus 100 according to one embodiment of the present disclosure comprises a camera 195, a display 180, a memory configured to store facial images of a registered user (140 of FIG. 2), and a signal processing device (170 of FIG. 2) configured to enter a monitoring mode if changes in images captured by the camera 195 exceed a predetermined value during operation, wherein, if a facial image within images captured through the camera 195 does not match a facial image stored in the memory 140 during the monitoring mode operation, the signal processing device 170 determines a theft situation and is configured to output an alarm or transmit the images captured through the camera 195 to the outside. Accordingly, a theft situation can be accurately detected in real-time. Also, the likelihood of recovery in theft situations can be improved. The above will be described with reference to FIG. 5 and subsequent figures.

The internal operation of the image display apparatus 100, such as the laptop computer, will be described in more detail with reference to FIG. 2 and subsequent figures.

FIG. 2 is an example of an internal block diagram of the image display apparatus of FIG. 1.

Referring to FIG. 2, an image display apparatus 100 according to one embodiment of the present disclosure includes an input device 120, an external device interface 130, a memory 140, a signal processing device 170, a display 180, an audio output device 185, a camera 195, a controller 270, a power supply 190, and a graphic processor 340.

The input device 120 may be equipped with various keys such as the power key 101 and the character key 150a and provide signals generated by the keys to the signal processing apparatus 170.

The external device interface 130 may provide an interface to connected external devices (not shown), such as USB devices or external devices connected through an HDMI port.

For example, the external device interface 130 may connect in a wired or wireless manner with external devices such as a Digital Versatile Disk (DVD), a Blu-ray device, a gaming console, a camera, a camcorder, or a set-top box; and may be configured to perform input/output operations with the external devices.

The network interface 135 provides an interface for connecting the image display apparatus 100 to a wired/wireless network including the Internet network. For example, the network interface 135 may receive, via the network, content or data provided by the Internet, a content provider, or a network operator.

Meanwhile, the network interface 135 may include a wireless communicator (not shown).

For example, the wireless communicator (not shown) within the network interface 135 may be configured to perform wireless communication with an adjacent access point device 700.

The memory 140 may store a program for each signal processing and control in the signal processing device 170 and may store signal-processed image, audio, or data signal.

In addition, the memory 140 may serve to temporarily store image, audio, or data signal input to the external device interface 130.

Meanwhile, the memory 140 stores facial images of a registered user.

Although FIG. 2 illustrates that the memory 140 is provided separately from the signal processing device 170, the scope of the present disclosure is not limited thereto. The memory 140 may be included in the signal processing device 170.

The interface 150 may transmit user input signals received wirelessly to the signal processing device 170 or the controller 270.

For example, the interface 150 may receive user input signals in a wired or wireless manner, generated by the operation of a remote control device 200, such as a wired or wireless mouse (not shown), and transmit the received user input signals to the signal processing device 170.

The controller 270 may be configured to enter a power saving mode or a standby mode when a power-off signal is received or a power saving or a standby mode signal is input, turn off a first DC/DC converter 430 within the power supply 190; when a power-on signal is received, the controller 270 is configured to turn on the first DC/DC converter 430 within the power supply 190.

For example, in the power saving or standby mode, only the controller 270 may operate in a power saving or standby state, while other devices may not operate at all. Accordingly, the power consumption of the image display apparatus 100 during the power saving mode or standby mode may be significantly reduced.

The power supply 190 may supply power to various devices within the image display apparatus 100. In the diagram, it is shown that power is supplied to the audio output device 185, the signal processing device 170, the controller 270, and the display 180; however, power may also be supplied to other components such as the input device 120, memory 140, network interface 135, external device interface 130, and interface 150.

The signal processing device 170 may be configured to perform signal processing for the overall operation of the image display apparatus 100.

For example, the signal processing device 170 may run various programs based on a predetermined operating system (OS).

Specifically, the signal processing device 170 may process video or audio signals stored in the memory 140 or input from external sources and output the processed signals.

In addition, the signal processing device 170 may generate and output graphics images, such as on-screen display (OSD) images.

Meanwhile, the signal processing device 170 may be implemented in the form of a System on Chip (SoC).

The display 180 may convert and display video signals, data signals, graphic image signals, control signals, and the like processed by the graphic processor 340 within the signal processing device 170.

The display 180 may be implemented using LCD, OLED, and flexible displays and may also support three-dimensional (3D) display.

Meanwhile, the display 180 may be configured as a touch screen and used as an input device in addition to an output device.

The audio output device 185 may receive audio signals processed in the signal processing device 170 and output sounds.

The camera 195 may be disposed in the upper part of the display 180 to capture images.

For example, the camera 195 may capture images that include the user's face. Also, the camera 195 may capture images that include the face of an outsider.

Images captured by the camera 195 may be transmitted to the signal processing device 170.

Meanwhile, a block diagram of the image display apparatus 100 shown in FIG. 2 is a block diagram for an embodiment of the present disclosure. Each component of the block diagram may be integrated, added, or omitted according to a specification of the image display apparatus 100 actually implemented. That is, two or more components may be combined into a single component as needed, or a single component may be divided into two or more components. The function performed in each block is described for the purpose of illustrating embodiments of the present disclosure, and specific operation and apparatus do not limit the scope of the present disclosure.

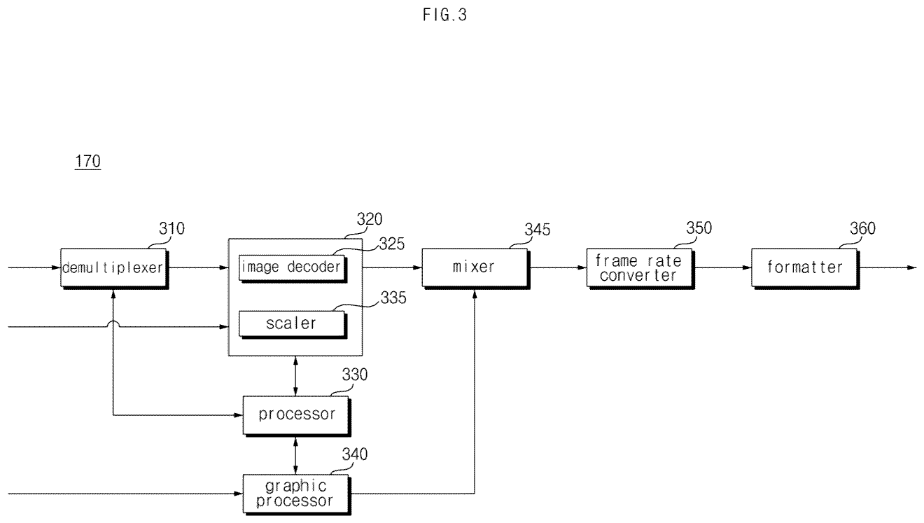

FIG. 3 is an example of an internal block diagram of the signal processing device of FIG. 2.

Referring to the figure, the signal processing device 170 according to one embodiment of the present disclosure may include a demultiplexer 310, an image processor 320, a processor 330, a graphic processor 340, a mixer 345, a frame rate converter 350, and a formatter 360. In addition thereto, the signal processing device 170 may further include an audio processor (not shown) and a data processor (not shown).

The demultiplexer 310 demultiplexes the input signal or stream. For example, when an MPEG-2 TS signal is input, the input MPEG-2 TS signal be demultiplexed into image, audio, and data signal, respectively.

The image processor 320 may be configured to perform image processing of demultiplexed image signals. To this end, the image processor 320 may include an image decoder 325 and a scaler 335.

The image decoder 325 decodes a demultiplexed image signal, and the scaler 335 performs scaling so that the resolution of the decoded image signal can be output from the display 180.

The image decoder 325 can include a decoder of various standards. For example, a 3D image decoder for MPEG-2, H.264 decoder, a color image, and a depth image, and a decoder for a multiple view image may be provided.

The processor 330 may control the overall operation within the image display apparatus 100 or the signal processing device 170.

Also, the processor 330 may control the image display apparatus 100 using the user command input through the interface 150 or through an internal program.

Also, the processor 330 may be configured to perform data transfer control with the network interface 135 or the external device interface 130.

Also, the processor 330 may control the operation of the demultiplexer 310, the image processor 320, and the graphic processor 340 within the signal processing device 170.

The graphic processor 340 generates a graphics image signal according to the user input or autonomously.

Also, the graphic processor 340 may generate a pointer that may be displayed on the display based on a pointing signal input from the remote control device 200.

Meanwhile, the graphic processor 340 may be configured to perform graphics processing on the image signal output from the signal processing device 170.

For example, the graphic processor 340 may be configured to perform graphics processing on the image signal output from the signal processing device 170 to add a predetermined graphics image.

The mixer 345 may combine the graphics image signals generated by the graphic processor 340 with the decoded video signals processed by the image processor 320. The mixed image signal is provided to the frame rate converter 350.

The frame rate converter (FRC) 350 may convert the frame rate of an input image. Meanwhile, the frame rate converter 350 can also directly output the frame rate without any additional frame rate conversion.

The formatter 360 may convert the format of an input image signal and output the image signal in the converted format. For example, the formatter 360 may convert a 2D image into a 3D image or convert the format of a 3D image.

Meanwhile, a block diagram of the signal processing device 170 shown in FIG. 3 is a block diagram for an embodiment of the present disclosure. Each component of the block diagram may be integrated, added, or omitted according to a specification of the signal processing device 170 actually implemented.

In particular, the frame rate converter 350 and the formatter 360 may not be provided within the signal processing device 170 but may be provided separately or integrated into a single module.

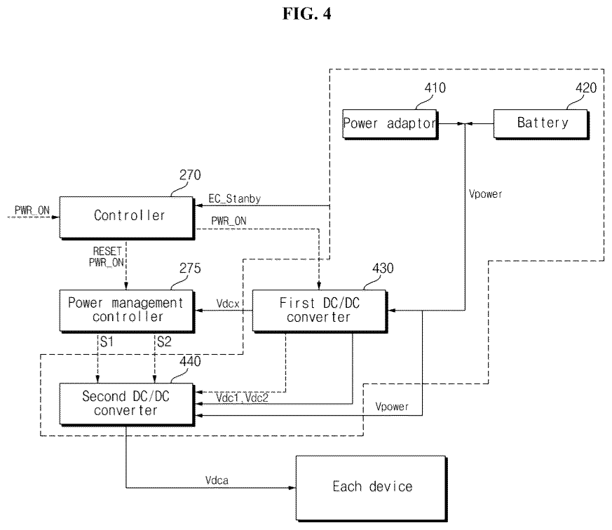

FIG. 4 is a diagram referenced to describe an example of operation of the control and the power supply of FIG. 2.

Referring to the figure, the image display apparatus 100 according to an embodiment of the present disclosure may further comprise a power supply 190 outputting DC power, an input device 120 that outputs a power-on signal PWR_ON or a power-off signal PWR_OFF based on the operation of a power key 101, and a controller 270 entering a power saving mode or a standby mode and controlling a first DC/DC converter 430 within the power supply 190 to turn off in response to the power-off signal being received or a power saving or standby mode signal being input, and controlling the first DC/DC converter 430 within the power supply 190 to turn on in response to the power-on signal being received. Accordingly, power consumption may be reduced in the standby mode.

The controller 270 may control the power supply 190 to turn off when the power-off signal PWR_OFF is received or the power saving or standby mode signal is input and control the power supply 190 to turn on when the power-on signal PWR_ON is received. Accordingly, power consumption may be reduced in the standby mode.

In particular, when the power-off signal PWR_OFF is received or the power saving mode or standby mode signal is received, the controller 270 may turn off the power supply, thereby reducing the power consumption in the power saving or standby mode.

Meanwhile, the power saving or standby mode is deactivated by the power-on signal PWR_ON, thereby enabling the operation of the DC/DC converter within the power supply.

Meanwhile, the controller 270 may be implemented as an embedded controller.

The power supply 190 may be configured to perform DC power conversion based on the power-on signal PWR_ON and supply the converted DC power to each device within the image display apparatus 100.

The power supply 190 may include a battery 420 that stores DC power Vpower input from an external source, a first DC/DC converter 430 that converts the DC power Vpower input from the external source or DC power Vpower stored in the battery 420 and output the converted DC power Vdc1, Vdc2, and a second DC/DC converter 440 that adjusts the level of the DC power converted from the first DC/DC converter 430 and output the adjusted DC power Vdca.

Meanwhile, the power supply 190 may refer to the concept that includes an external power adaptor 410.

The battery 420 may store DC power supplied from the power adapter 410 when AC power from the power adapter 410 is converted into DC power and the converted DC power is supplied.

Meanwhile, the image display apparatus 100 according to an embodiment of the present disclosure may further include a power management controller 275.

The power management controller 275 may be configured to output control signals S1, S2 to the second DC/DC converter 440 within the power supply 190 in response to receiving the power-on signal PWR_ON.

Meanwhile, the first DC/DC converter 430 may be configured to output DC power Vdcx to the power management controller 275 and may be configured to output a control signal Sa to the second DC/DC converter 440 upon receiving the power-on signal PWR_ON from the controller 270.

Meanwhile, the power supply 190 may supply standby power EC_Standby to the controller 270 in the power saving or standby mode.

Meanwhile, by disabling the output of DC power except for the standby power EC_Standby in the power saving or standby mode of the image display apparatus 100, power consumption may be reduced in the power saving or standby mode.

In the power saving or standby mode, the battery 420 within the power supply 190 may be configured to output the standby power EC_Standby, while the first DC/DC converter 430 within the power supply 190 may be turned off.

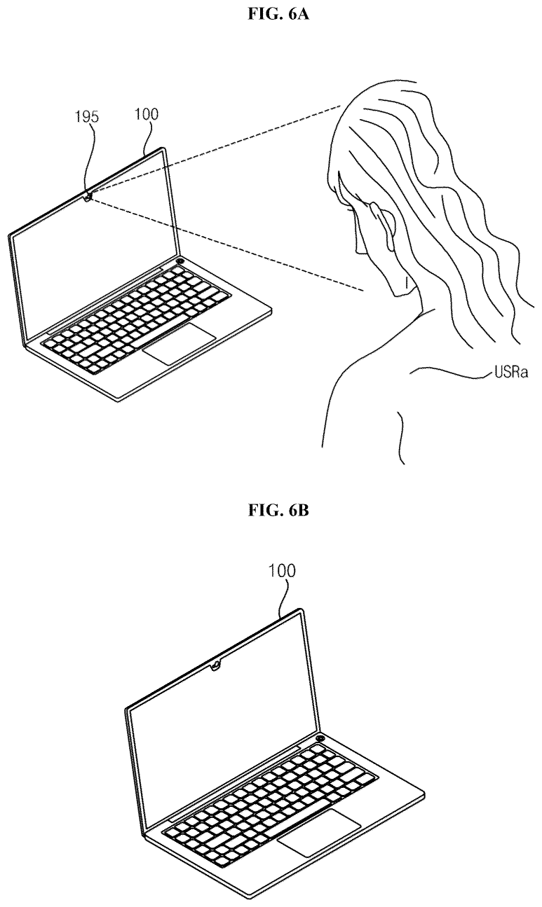

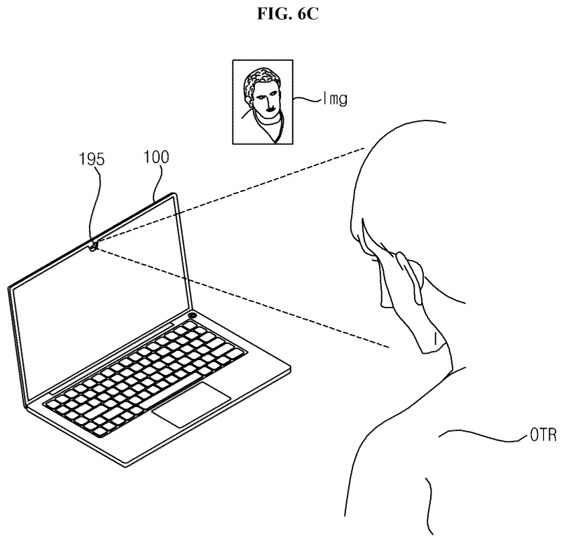

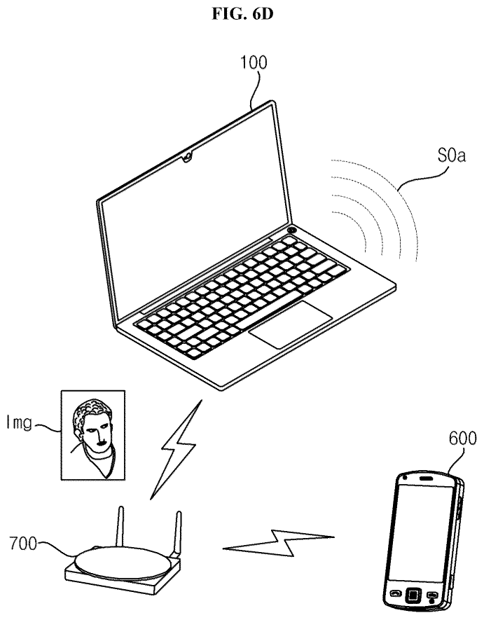

FIG. 5 is a flow diagram illustrating an example of an operation method of an image display apparatus according to an embodiment of the present disclosure, and FIGS. 6A to 6D are drawings referenced to describe the operation method of FIG. 5.

Referring to the figure, the signal processing device 170 of the image display apparatus 100 may be configured to store or register a registered user's facial image captured using the camera 195 in the memory S510.

Next, the signal processing device 170 activates the camera 195 during operation S520.

For example, the signal processing device 170 may be configured to activate the camera 195 when a character key 150a is operated.

In another example, the signal processing device 170 may be configured to activate the camera 195 when the image displayed on the display 180 varies rather than remaining constant.

In yet another example, the signal processing device 170 may be configured to activate the camera 195 if sound is output through the audio output device 185 while the same image is displayed on the display 180 for a predetermined period.

The signal processing device 170 may sequentially receive the captured images from the camera 195 after the camera 195 is activated.

At this time, the signal processing device 170 may control the image capture frequency of the camera 195 to increase as the operation cycle of the character key 150a or the change cycle of the image displayed on the display 180 lengthens. Accordingly, as the operation input slows down, captured images may be obtained more frequently.

FIG. 6A illustrates a situation in which an image of the user USRa is captured after the camera 195 is activated. As shown in FIG. 6A, after the camera 195 is activated, an image that captures the face of the user USRa may be transmitted to the signal processing device 170.

Next, the signal processing device 170 may be configured to determine whether a change in the captured images is larger than or equal to a predetermined value S530 and, if so, control the apparatus to enter the monitoring mode S540.

For example, if a difference between a first image and a second image captured sequentially is larger than or equal to the predetermined value, the signal processing device 170 may be configured to enter the monitoring mode.

Specifically, the signal processing device 170 may be configured to determine that the user USRa has left their seat and control the apparatus to enter the monitoring mode if the face of the user USRa, which is included in the first captured image, is not included or only partially included in the second image captured after the first image.

FIG. 6B illustrates a situation where the face of the user USRa is not included in a captured image due to the user USRa leaving their seat after activation of the camera 195. Accordingly, the signal processing device 170 may be configured to enter monitoring mode.

Meanwhile, the signal processing device 170 may be configured to operate in a normal mode if the facial image captured by the camera 195 matches the facial image stored in the memory 140 during operation; on the other hand, if the captured facial image does not match the facial image stored in the memory 140 for a predetermined period during operation, the signal processing device 170 may be configured to enter the monitoring mode. Accordingly, a theft situation can be accurately detected in real-time.

Next, while operating in the monitoring mode, the signal processing device 170 may monitor internal devices S550.

Meanwhile, the signal processing device 170 may be configured to perform monitoring based on at least one of power connection status, open/close status of the display 180, input status of the character key 150a, or presence/absence of the user's face in the image captured by the camera 195.

For example, the signal processing device 170 may be configured to perform monitoring based on images obtained through the camera 195 while operating in the monitoring mode after the user USRa has left their seat.

In another example, the signal processing device 170 may be configured to perform monitoring based on images obtained through the camera 195 and the open/close status of the display 180 while operating in the monitoring mode after the user USRa has left their seat.

In yet another example, the signal processing device 170 may be configured to perform monitoring based on images obtained through the camera 195 and the input status of the character key 150a while operating in the monitoring mode after the user USRa has left their seat.

The signal processing device 170 assesses a theft situation from the monitoring of internal devices S560; if the monitoring result indicates a theft situation, the signal processing device 170 is configured to output an alarm or transmit captures images S570.

For example, the signal processing device 170 may be configured to determine a theft situation if the image captured through the camera 195 does not match the facial image stored in the memory 140 and output an alarm through the audio output device 185 or transmit images captured through the camera 195 to the outside through the network interface 135.

FIG. 6C illustrates an example where an image Img including the face of an outsider OTR is obtained through the camera 195 while operating in the monitoring mode, and FIG. 6D illustrates an example where an alarm is output and an images is transmitted based on the determination of a theft situation.

The signal processing device 170 may be configured to determine a theft situation if the image that includes the face of an outsider OTR does not match the facial image stored in the memory 140 and, as shown in FIG. 6D, control the apparatus to output an alarm Soa through the audio output device 185 or transmit an image Img captured through the camera 195 to the outside through the network interface 135. Accordingly, a theft situation can be accurately detected in real-time. Also, the likelihood of recovery in theft situations can be improved.

FIG. 6D illustrates a situation where an image Img captured through the camera 195 is transmitted to an external mobile terminal 600 via an adjacent access point device 700.

For example, the signal processing device 170 or the network interface 135 may be configured to prioritize connection to an open access point device with the strongest wireless signal strength and no password protection when the image display apparatus 100 is located in a public place.

Additionally, upon determining a theft situation, the signal processing device 170 may be configured to connect wirelessly to the open access point device 700 and transmit images captured through the camera 195 to a registered mobile device 600 or a server. Accordingly, the likelihood of recovery in theft situations can be improved.

In another example, the signal processing device 170 may be configured to determine a theft situation and output an alarm through the audio output device 185 or transmit an image captured through the camera 195 to the outside through the network interface 135 if the facial image within the image captured through the camera 195 does not match the facial image stored in the memory 140 and no input is detected from the power key 101 or the character key 150a for a predetermined period during operation in the monitoring mode. Accordingly, a theft situation can be accurately detected in real-time. Also, the likelihood of recovery in theft situations can be improved.

In yet another example, the signal processing device 170 may be configured to determine a theft situation and output an alarm through the audio output device 185 or transmit an image captured through the camera 195 to the outside through the network interface 135 if the facial image within the image captured through the camera 195 does not match the facial image stored in the memory 140 and the display 180 is closed during operation in the monitoring mode. Accordingly, a theft situation can be accurately detected in real-time. Also, the likelihood of recovery in theft situations can be improved.

In still another example, the signal processing device 170 may be configured to determine a theft situation and output an alarm through the audio output device 185 or transmit an image captured through the camera 195 to the outside through the network interface 135 if the facial image within the image captured through the camera 195 does not match the facial image stored in the memory 140 and the character key 150a or the power key 101 is input during operation in the monitoring mode. Accordingly, a theft situation can be accurately detected in real-time. Also, the likelihood of recovery in theft situations can be improved.

Meanwhile, upon determining a theft situation, the signal processing device 170 may be configured to lock the screen of the display 180 and prevent the power mode from entering an off mode or a power saving mode. Accordingly, personal information exposure may be minimized in theft situations.

Meanwhile, in response to determining the theft situation, the signal processing device 170 may be configured to not to turn off power when a power-off input is applied via the power key 101 or reboot after power-off.

Meanwhile, in response to determining the theft situation, the signal processing device 170 may be configured to lock BIOS data or personal information data stored in the memory 140. Accordingly, personal information exposure may be minimized in theft situations.

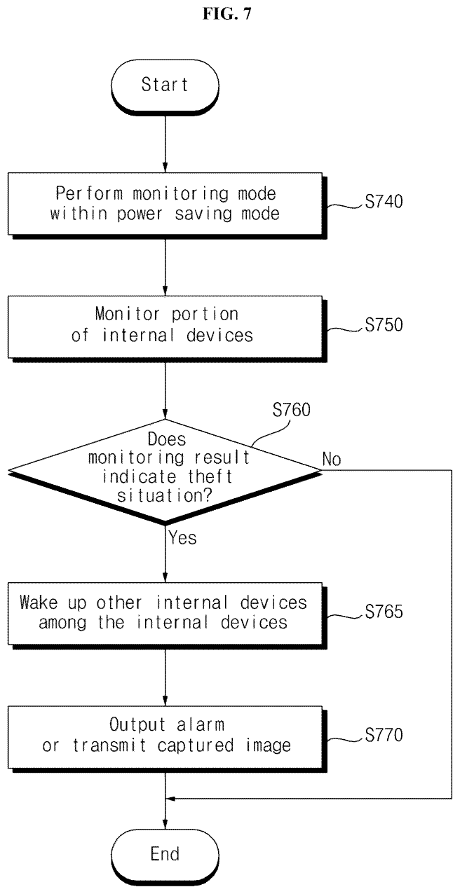

Meanwhile, although FIG. 5 illustrates transition from the normal operation mode to the monitoring mode, it is also possible to transition from the power saving mode to the monitoring mode. The transitioning will be described with reference to FIG. 7 and subsequent figures.

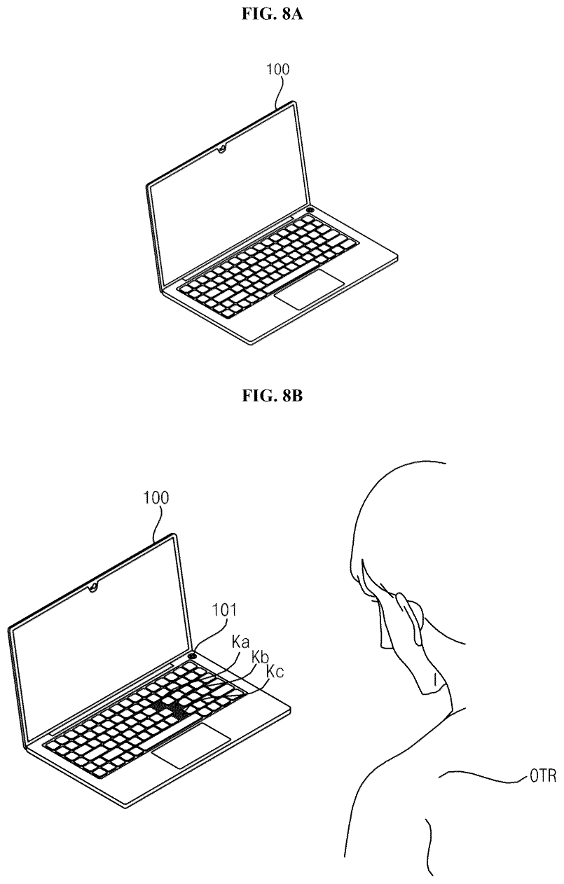

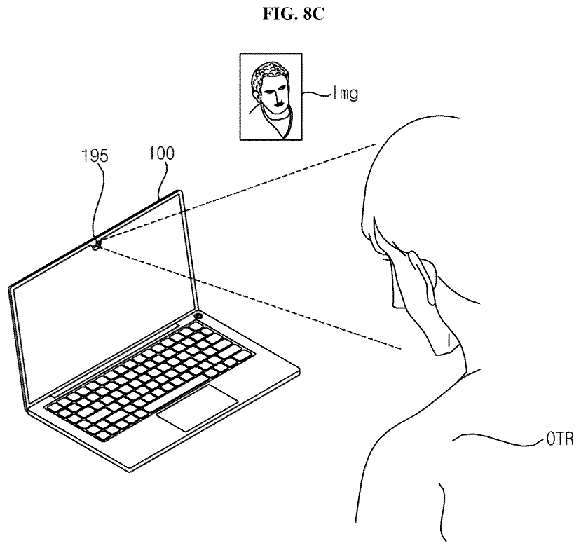

FIG. 7 is a flow diagram illustrating another example of an operation method of an image display apparatus according to an embodiment of the present disclosure, and FIGS. 8a to 8d are drawings referenced to describe the operation method of FIG. 7.

Referring to the figure, the signal processing device 170 performs the monitoring mode during the power saving mode operation S740.

For example, the signal processing device 170 may control the camera 195 to be activated during the power saving mode operation and control the apparatus to enter the monitoring mode if the change in captured images exceeds a predetermined value as the camera 195 is activated.

For example, if a difference between a first image and a second image captured sequentially is larger than or equal to the predetermined value, the signal processing device 170 may be configured to enter the monitoring mode.

Specifically, the signal processing device 170 may be configured to determine that the user USRa has left their seat and control the apparatus to enter the monitoring mode if the face of the user USRa, which is included in the first captured image, is not included or only partially included in the second image captured after the first image.

FIG. 8A illustrates a situation where the face of the user USRa is not included in a captured image due to the user USRa leaving their seat after activation of the camera 195. Accordingly, the signal processing device 170 may be configured to enter monitoring mode.

Next, the signal processing device 170 may be configured to activate only a portion of internal devices during the power saving mode operation and perform monitoring based on the activated portion of the internal devices S750.

Next, the signal processing device 170 may assess a theft condition from the monitoring result based on the portion of internal devices S760 and, in response to the monitoring result indicating a theft situation, further wake up other internal devices S756 and output an alarm or transmit images captured through the camera 195 to the outside S770.

Accordingly, a theft situation can be accurately detected in real-time. Also, the likelihood of recovery in theft situations can be improved.

For example, the signal processing device 170 or the controller 270 may be configured to activate only the input device 120 and the power supply 190 in the power saving mode but deactivate the camera 195, the display 180, the audio output device 185, the network interface 135, and the external device interface 130.

Meanwhile, as shown in FIG. 8B, when an input is received from a predetermined key Ka, Kb, Kc among the character keys 150a during the power saving mode operation, the signal processing device 170 may receive a signal from the activated input device 120 and control the apparatus to enter the monitoring mode based on the received signal.

Meanwhile, during the power saving mode operation, the signal processing device 170 may enter the monitoring mode and activate the camera 195.

As shown in FIG. 8C, The signal processing device 170 may be configured to determine a theft situation if the facial image Img within an image captured by the camera 195 does not match the facial image stored in the memory 140 during the power saving mode operation, the signal processing device 170 may be configured to determine a theft situation, activate the network interface 135 and the audio output device 185, and output an alarm through the audio output device 185 or transmit the image Img captured through the camera 195 to the outside through the network interface 135. Accordingly, a theft situation can be accurately detected in real-time. Also, the likelihood of recovery in theft situations can be improved.

In another example, the signal processing device 170 or the controller 270 may be configured to activate only the camera 195, the input device 120, and the power supply 190 in the power saving mode but deactivate the display 180, the audio output device 185, the network interface 135, and the external device interface 130.

Meanwhile, as shown in FIG. 8B, when an input is received from a predetermined key Ka, Kb, Kc among the character keys 150a during the power saving mode operation, the signal processing device 170 may receive a signal from the activated input device 120 and control the apparatus to enter the monitoring mode based on the received signal.

As shown in FIG. 8C, The signal processing device 170 may be configured to determine a theft situation if the facial image Img within an image captured by the camera 195 does not match the facial image stored in the memory 140 during the power saving mode operation, the signal processing device 170 may be configured to determine a theft situation, activate the network interface 135 and the audio output device 185, and output an alarm through the audio output device 185 or transmit the image Img captured through the camera 195 to the outside through the network interface 135. Accordingly, a theft situation can be accurately detected in real-time. Also, the likelihood of recovery in theft situations can be improved.

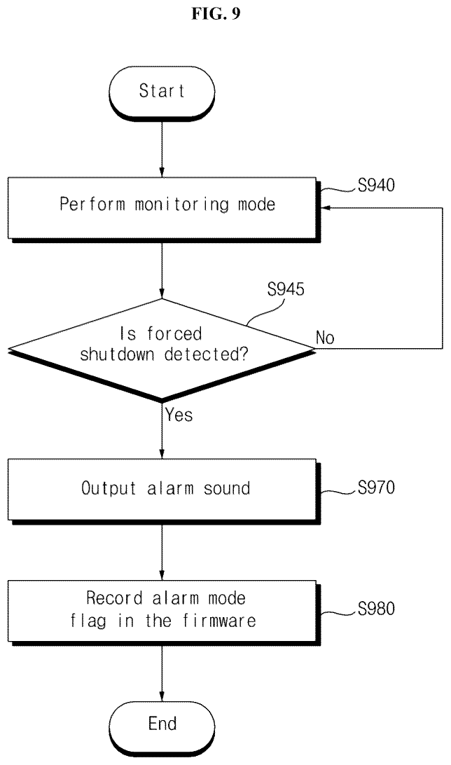

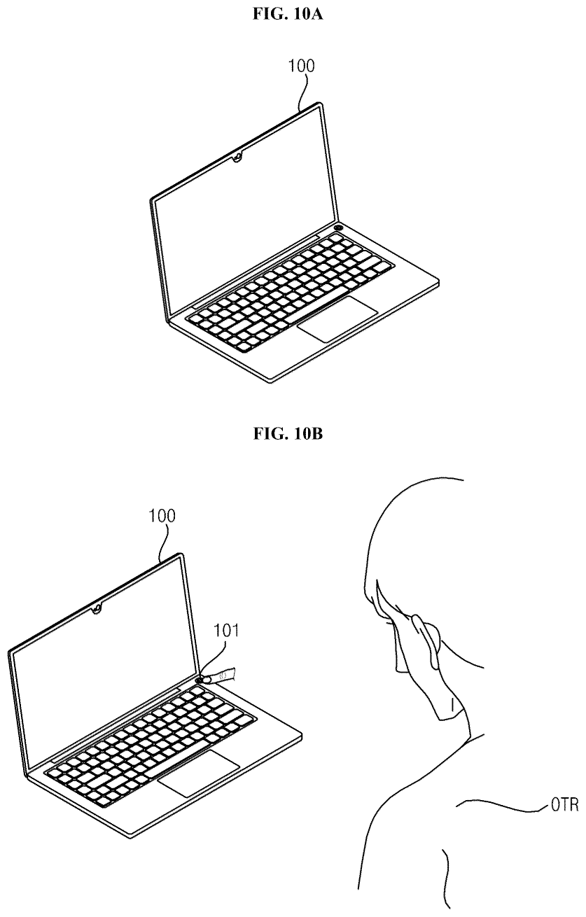

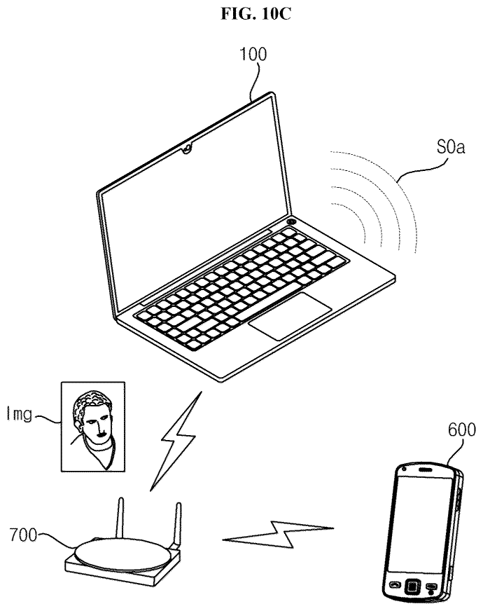

FIG. 9 is a flow diagram illustrating another example of an operation method of an image display apparatus according to an embodiment of the present disclosure, and FIGS. 10A to 8C are drawings referenced to describe the operation method of FIG. 9.

Referring to the figure, the signal processing device 170 performs the monitoring mode S940.

For example, the signal processing device 170 may control the camera 195 to be activated during the power saving mode operation and control the apparatus to enter the monitoring mode if the change in captured images exceeds a predetermined value as the camera 195 is activated.

For example, if a difference between a first image and a second image captured sequentially is larger than or equal to the predetermined value, the signal processing device 170 may be configured to enter the monitoring mode.

FIG. 10A illustrates a situation where the face of the user USRa is not included in a captured image due to the user USRa leaving their seat after activation of the camera 195. Accordingly, the signal processing device 170 may be configured to enter monitoring mode.

Next, the signal processing device 170 determines whether a forced shutdown input is received during the monitoring mode operation S945 and output an alarm if the forced shutdown input is detected S970.

The signal processing device 170 may be configured to store an alarm mode flag in the memory 140 S980. Accordingly, the likelihood of recovery in theft situations can be improved.

FIG. 10B illustrates a case where the power key 101 is operated for more than a predetermined period during the monitoring mode operation.

If the power key 101 is pressed for more than a predetermined period in the normal mode rather than the monitoring mode, the power of the image display apparatus 100 is turned off in response to the forced shutdown input.

Meanwhile, as shown in FIG. 10B, if the power key 101 is pressed for more than a predetermined period by an outsider OTR during the monitoring mode operation, the signal processing device 170 or the controller 270 may control the image display apparatus 100 not to execute the off or power saving mode or to reboot after power-off to prevent theft of the image display apparatus 100 even in the presence of the forced shutdown input.

Specifically, as shown in FIG. 10B, if the power key 101 is pressed for more than a predetermined period by an outsider OTR during the monitoring mode operation, the signal processing device 170 or the controller 270 may be configured to determine a theft situation and control the image display apparatus 100 not to execute the off or power saving mode or to reboot after the apparatus is powered off to prevent theft of the image display apparatus 100.

In particular, upon determining a theft situation, the signal processing device 170 may be configured to output a notification screen on the display 180 and an alert sound during rebooting after the apparatus is turned off until the operating system is loaded. Accordingly, the likelihood of recovery in theft situations can be improved.

Furthermore, as shown in FIG. 10C, if the power key 101 is pressed for more than a predetermined period by an outsider OTR during the monitoring mode operation, the signal processing device 170 may be configured to output an alarm Soa or transmit an image Img captured through the camera 195 to an external mobile terminal 600 via an adjacent access point device 700. Accordingly, a theft situation can be accurately detected in real-time. Also, the likelihood of recovery in theft situations can be improved.

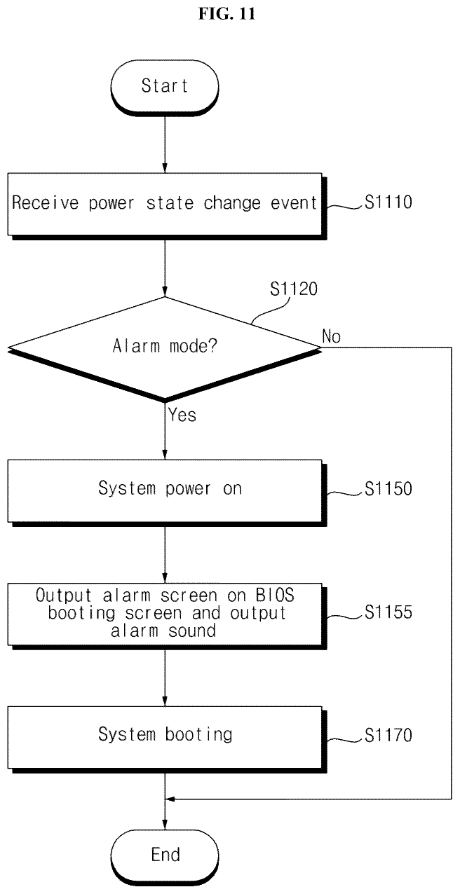

FIG. 11 is a flow diagram illustrating yet another example of an operation method of an image display apparatus according to an embodiment of the present disclosure.

Referring to the figure, the signal processing device 170 or the controller 270 receives a power state change event, such as power-off S1110.

For example, if the power key 101 is pressed for more than a predetermined period during the monitoring mode operation, a forced shutdown input event is generated.

Next, the signal processing device 170 or the controller 270 determines whether the event indicates an alarm mode S1120 and is configured to turn on the system power if the event indicates the alarm mode S1150.

For example, if a forced shutdown input event occurs during the monitoring mode operation, the signal processing device 170 or the controller 270 may be configured to determine a theft situation and control the apparatus to enter the alarm mode and reboot the apparatus to turn on the system again after the apparatus is turned off according to the forced shutdown input.

Next, the signal processing device 170 may be configured to display an alarm screen on the BIOS boot screen and output an alarm sound S1155; subsequently, the signal processing device 170 may boot the system S1170.

For example, the signal processing device 170 may be configured to display an alarm screen on the display 180 and output an alarm sound through the audio output device 185 until the operating system screen is displayed. Accordingly, the likelihood of recovery in theft situations can be improved.

Meanwhile, an image display apparatus 100 according to another embodiment of the present disclosure comprises a camera 195, a display 180, and a memory 140 for storing facial images of a registered user, and a signal processing device 170 activating only a portion of internal devices during a power saving mode operation and perform monitoring based on the portion of the internal devices, wherein, in response to the monitoring result indicating a theft situation, the signal processing device 170 is configured to further wake up other internal devices among the internal devices and output an alarm or transmit images captured through the camera 195 to the outside. Accordingly, a theft situation can be accurately detected in real-time. Also, the likelihood of recovery in theft situations can be improved.

While the present disclosure has been particularly shown and described with reference to exemplary embodiments thereof, the present disclosure is not limited to the specific embodiments described above. it is obvious that various modifications may be made by those skilled in the art, to which the present disclosure pertains without departing from the gist of the present disclosure, which is claimed in the claims, and such modified embodiments should not be individually understood from the technical spirit or prospect of the present disclosure.

What is claimed is:

1. An image display apparatus comprising:
a camera;
a display;
a memory configured to store facial images of a registered user; and
a signal processing device configured to enter a monitoring mode in response to changes in images captured by the camera exceeding a predetermined value during operation,
wherein, in response to a facial image within images captured through the camera does not matching a facial image stored in the memory during the monitoring mode operation, the signal processing device is configured to determine a theft situation and output an alarm or transmit the images captured through the camera to the outside.

2. The apparatus of claim 1, wherein the signal processing device is configured to operate in a normal mode in response to the facial image captured by the camera matching the facial image stored in the memory during operation, and,
in response to the facial image captured by the camera does not matching the facial image stored in the memory for a predetermined period, the signal processing device is configured to enter the monitoring mode.

3. The apparatus of claim 1, further comprising:
an input device including a power key and a character key,
wherein the signal processing device is configured to determine a theft situation and output an alarm or transmit the image captured through the camera to the outside in response to the facial image within the image captured through the camera not matching the facial image stored in the memory and no input being detected from the power key or the character key for a predetermined period during operation in the monitoring mode.

4. The apparatus of claim 1, wherein, in response to determining the theft situation, the signal processing device is configured to lock the screen of the display and prevent the power mode from entering an off mode or a power saving mode.

5. The apparatus of claim 1, wherein, in response to determining the theft situation and a power-off input being applied via a power key, the signal processing device is configured to not turn off power or reboot after power-off.

6. The apparatus of claim 1, wherein, in response to determining the theft situation, the signal processing device is configured to lock BIOS data or personal information data stored in the memory.

7. The apparatus of claim 1, further comprising:
a network interface configured to perform wireless communication with an adjacent access point device,
wherein in response to determining the theft situation, the signal processing device is configured to connect wirelessly to the access point device and transmit the image captured through the camera to a registered mobile terminal or a server.

8. The apparatus of claim 1, wherein during a power saving mode operation, the signal processing device is configured to activate only a portion of internal devices and perform monitoring based on the activated portion of the internal devices and,
in response to the monitoring result indicating the theft situation, the signal processing device is configured to further wake up other internal devices and output the alarm or transmit images captured through the camera to the outside.

9. The apparatus of claim 1, further comprising:
a network interface configured to perform wireless communication with an adjacent access point device; and
an audio output device configured to output sound,
wherein the signal processing device is configured to activate the camera during the power saving mode operation, determine the theft situation in response to the facial image captured by the camera does not matching the facial image stored in the memory, activate the network interface and the audio output device, and output an alarm through the audio output device or transmit images captured through the camera to the outside through the network interface.

10. The apparatus of claim 1, wherein, in response to a forced shutdown input being detected during the monitoring mode operation, the signal processing device is configured to output an alarm and store an alarm mode flag in the memory.

11. The apparatus of claim 1, further comprising:
a power supply configured to output DC power;
an input device configured to output a power-on signal or a power-off signal based on the operation of a power key; and
a controller configured to enter a power saving mode or a standby mode and controlling a DC/DC converter within the power supply to turn off in response to the power-off signal being received or a power saving or standby mode signal being input, and turn on the DC/DC converter within the power supply in response to the power-on signal being received.

12. The apparatus of claim 11, wherein the controller is configured to turn off the power supply in response to the power-off signal being received or the power saving or standby mode signal being input, and turn on the power supply in response to the power-on signal being received,
wherein the power supply is configured to perform DC power conversion based on the power-on signal and supply the converted DC power to each device within the image display apparatus.

13. The apparatus of claim 11, wherein the power supply includes:
a battery configured to store DC power input from an external source;
the DC/DC converter configured to convert the DC power input from the external source or DC power stored in the battery and output the converted DC power; and
a second DC/DC converter configured to adjust the level of the DC power converted from the DC/DC converter and output the adjusted DC power.

14. The apparatus of claim 13, further including:
a power management controller configured to receive a power-on signal from the signal processing device,
wherein the power management controller is configured to output a control signal to the second DC/DC converter within the power supply in response to receiving of the power-on signal.

15. An image display apparatus comprising:
a camera;
a display;
a memory configured to store facial images of a registered user; and
a signal processing device configured to activate only a portion of internal devices during a power saving mode operation and perform monitoring based on the portion of the internal devices,
wherein, in response to the monitoring result indicating a theft situation, the signal processing device is configured to further wake up other internal devices among the internal devices and output an alarm or transmit images captured through the camera to the outside.

16. The apparatus of claim 15, further comprising:
a network interface configured to perform wireless communication with an adjacent access point device; and
an audio output device configured to output sound,
wherein the signal processing device is configured to activate the camera during the power saving mode operation, determine the theft situation in response to the facial image captured by the camera does not matching the facial image stored in the memory, activate the network interface and the audio output device, and output an alarm through the audio output device or transmit images captured through the camera to the outside through the network interface.

17. The apparatus of claim 15, wherein, in response to a forced shutdown input being detected during the monitoring mode operation, the signal processing device is configured to output an alarm and store an alarm mode flag in the memory.
